(19) United States
(12) Patent Application Publication
(10) Pub. No.: US 2005/0014097 A1
(43) Pub. Date: Jan. 20, 2005

(54) Use of oxidable spinels for optical recording

(76) Inventors: Philippe Tailhades, Saint-Orens (FR); Corinne Bonningue, Toulouse (FR); Isabelle Pasquet, Toulouse (FR); Lionel Presmanes, Castanet (FR)

Correspondence Address: OLIFF & BERRIDGE, PLC, P.O. BOX 19928, ALEXANDRIA, VA, 22320, US

(21) Appl. No.: 10/495,020

(22) PCT Filed: Nov. 8, 2002
(86) PCT No.: PCT/FR02/03837

(30) Foreign Application Priority Data
Nov. 12, 2001 (FR) 01 14596

(51) Int. Cl. G11B 7/24

(52) U.S. Cl. 430/270.12; 430/945; 369/288; 428/64.8

(57) ABSTRACT

The present invention relates to a method of recording data in digital form on a write-once read-many optical medium comprising a sensitive film based on a metal oxide of the oxidizable spinel type. Regions of the sensitive film are heated, locally and in succession, under conditions allowing oxidation of the oxidizable metal ions of the oxide. In the optical medium thus recorded, the virgin regions, which are not modified by the write operation, are oxidizable and change color after heat treatment in an oxidizing atmosphere.

The invention relates to a novel method of recording data in digital form on a write-once read-many optical medium.

More precisely, the invention relates to a recording method that makes use of simultaneous phenomena of oxidation, crystallization and topographic deformation that occur in films of oxidizable spinel oxides of transition metals after brief local heating by a laser spot of suitable power. The data written may be read by detecting differences in optical properties between the written areas and the virgin areas.

It is known that data in digital form uses binary data elements or bits. The two states of the binary data are generally symbolized by the numbers 0 and 1. In optical media, such as disks, tapes or cards, the data bits are recorded in the form of a succession of localized physical modifications along a track on a recording layer, also called a sensitive film. The presence of such modification and its absence represent the two states of the binary data. Reading the recorded data consists in detecting these modifications and these absences of modification using suitable optical means.

For storing the data, and especially for archiving, WORM (write-once read-many) data media are used.

There are also CD-ROMs and DVD-ROMs (nonrewritable, prerecorded disks) that are used for the mass dissemination of various types of data, such as sounds, images or even software.

The materials used hitherto for CD-ROM or DVD-ROM media or for WORM media are either metals or organic materials. Such materials may be sensitive to oxidation (in the case of metal) or to moisture (in the case of metals and polymers). These materials are furthermore subject to relaxation phenomena over time (in the case of polymers and amorphous metals). Such aging phenomena are liable to affect the permanency and reliability of the recorded data.

There is therefore a need for new recording media and new writing methods that guarantee the durability of the recorded data, including in the field of archiving, which presupposes long-term storage.

Another objective of the research in the field of data storage is to increase the recording density so as to store ever increasing amounts of data per unit area of the recording medium. For all current optical recording techniques, the storage density is limited by light diffraction phenomena, such that the smallest marks representing the data bits that. can be read with a conventional optical system have a diameter that is proportional to the wavelength of the light radiation used for reading and which is inversely proportional to the numerical aperture of the objective of the optical read head. It is therefore important to be able to use wavelengths as short as possible. At the present time, the wavelengths used lie within the 650-780 nm spectral range.

It is therefore desirable to seek novel recording materials capable of using shorter wavelengths, of less than 600 nm.

It has now been discovered that thin films of certain spinel oxides of transition metals can be used as irreversible recording layers in write-once read-many optical recording media. The spinel oxides that can be used are oxidizable spinel oxides, whether stoichiometric or substoichiometric, containing transition metals that can have several oxidation states. The interest in these materials lies in their great chemical and structural stability around room temperature. Moreover, they can generally be used within a wide spectral range, including at short wavelengths around 400 nm, and they therefore allow data to be stored with high densities. Finally, the data media obtained according to the invention can be produced in very simple optical configurations consisting of a substrate (made of glass or polymer) and the sensitive film.

The optical data media obtained according to the invention may be used conventionally, with the laser beam passing firstly through the substrate and then the sensitive film, and in this case an optically absorbent layer, whose function will be explained in detail later, may be placed behind the sensitive film. The optical data media according to the invention can also be used in what are called near-field techniques, in which the laser beam passes firstly through the sensitive film. In near-field techniques, a flat miniaturized optical head very close to the surface of the sensitive film, at a few hundred nanometers, in a manner similar to the technique used for magnetic hard disks. Thanks to the mechanical hardness of the material of the sensitive film used, the invention provides optical media that can be used in near-field techniques, without it being necessary to coat the sensitive film with a protective layer. Moreover, the sensitive film is chemically very stable over a wide temperature range. Thus, whatever the type of use, the sensitive film does not need to be protected.

In the present application, the term “spinel oxide of stoichiometric type” is understood to mean oxides in which the metal/oxygen atomic ratio is close to 3/4.

Certain nonstoichiometric (cation-deficient) spinel ferrites obtained by oxidation of stoichiometric spinel ferrites have already been proposed for magnetooptic recording. The optical data media obtained are of the erasable and rewritable type (French patent No. 2 714 205 and U.S. Pat. No. 6,017,645).

Nonstoichiometric (cation-deficient) spinel ferrites obtained by oxidation of stoichiometric spinel ferrites have also already been proposed for optical recording of the WORM type (PCT International Application WO 99/14747). The recording method consists in locally heating regions of the sensitive film to a temperature at which the nonstoichiometric spinel oxide (with a spinel structure) is transformed irreversibly into a different crystal structure (a carborundum-type structure). The formation of a sensitive film based on nonstoichiometric spinel oxide has the drawback of requiring an oxidizing heat treatment after the deposition of the sensitive film on a substrate. The need for such a heat treatment limits the choice of constituent materials for the substrate on which the sensitive film is deposited.

By contrast, the recording media that can be used according to the invention do not require heat treatments. They are obtained simply by depositing the sensitive film and possibly a reflective layer, thereby making it possible in particular to use the strain phenomena associated with the deposition of thin films. This is because it is known that reduced-pressure physical deposition processes generally result in the formation of strained films. In the recording method of the invention, the existence of such strains makes writing easier, as will be seen in the experimental part below.

The subject of the invention is therefore a method of recording data in digital form on a write-once read-many optical medium comprising a sensitive film deposited, in thin-film form, on a substrate, said method comprising recording steps consisting in heating, locally and in succession, regions of the sensitive film, said sensitive film being made of an oxidizable material which comprises, apart from optional dopants present, an oxidizable spinel oxide comprising, in oxide form, at least two transition metals having different oxidation states. Since the oxides that can be used are of the spinel type, they are characterized by a metal atom/oxygen atom ratio close to 3/4, but which may be greater than 3/4 in the case of substoichiometric oxides. In fact, these oxides are ionic compounds so that the metal atom/oxygen atom ratio is in reality the cation/anion molar ratio.

Preferably, the sensitive film essentially consists of an oxidizable spinel oxide.

In the recording method according to the invention, said heating is carried out under conditions allowing oxidization of said oxidizable spinel oxide.

Since the spinel oxides used are oxidizable, they obviously contain at least one oxide of a metal capable of exhibiting several oxidation states, such as for example copper, iron, manganese, molybdenum, vanadium, tungsten and the rare earths.

The spinel oxides that can be used may contain a single metal, which is then present, in the oxide, in two different oxidation states, such as for example iron or manganese in the oxides Fe₃O₄ or Mn₃O₄.

Other metals that may be present in the spinel oxides that can be used are especially cobalt, chromium, aluminum, magnesium, nickel, zinc, etc.

Among the oxidizable spinel oxides that can be used, mention may be made in particular of those of formula I:
Mₓ³⁺M′_{y}ⁿ⁺M″_{z}²⁺O_{4+δ}²⁻ (I)
in which M represents at least one trivalent metal chosen from Fe, Mn, Co, Cr and Al;
M′ represents at least one metal that can have several oxidation states;
M″ is a divalent metal chosen from Mg, Co, Ni, Cu and Zn;
n is the valency of M′ in the M′ⁿ⁺ ion, which is an ion that can oxidize to an ion of higher valency than n;
x represents the quantity of atoms of metal M and may vary from 0.8 to 2.8 approximately;
y is a number representing the quantity of M′ atoms and is at least equal to approximately 0.2;
z is a number, possibly zero, representing the quantity of M″ atoms;
δ is a number equal to (3x+ny+2z−8)/2; and the sum (x+y+z) being equal to 3.

With the oxides of formula I, the recording method of the invention is carried out by heating under conditions allowing oxidation of the M′ⁿ⁺ ion or ions.

A few known properties of spinel oxides of transition metals will be reviewed below, taking the example of spinel ferrites (a case in which M in the above formula I represents Fe). The other spinel oxides, and especially those of formula I, generally have similar properties.

It is known that the structure of the spinel (MgAl₂O₄) is also that of magnetite Fe₃O₄. It is also known that the oxidation of magnetite results in iron sesquioxide Fe₂O₃, which retains the crystal structure of magnetite, in the form called γ-Fe₂O₃, up to a temperature of approximately 460° C., when the γ-Fe₂O₃ oxide transforms to α-Fe₂O₃, which has the structure of carborundum.

It is also known that iron oxides are ionic compounds and that the structure of α-Fe₂O₃, which is obtained by oxidation of magnetite, is a nonstoichiometric spinel structure. To be specific, during the oxidation of Fe₃O₄, negative oxygen ions are absorbed on the surface of this oxide and arrange themselves in an organization of the face-centered cubic type, as in the magnetite lattice, of which they constitute an extension. The negative charges thus provided are compensated for by oxidation of the ferrous ions to ferric ions, which then migrate toward the new arrangement of oxygen anions, the cohesion of which they provide by establishing Fe³⁺—O²⁻ bonds. At the end of oxidation, the spinel structure is maintained. However, the cation/anion ratio, initially 3/4, has become smaller owing to the introduction of anions. The crystal of the oxidized product then includes vacant sites, called vacancies. Stoichiometric spinel ferrites, generally represented by a formula of the type XFe₂O₄, where X is at least one divalent metal, can also be converted into nonstoichiometric spinel oxides, especially by oxidation. It is also known that, by introducing into the spinel oxides various substituents consisting of metals having multiple valency states, it is possible to create vacancies and to vary the number thereof.

The term “cation-deficient (or superstoichiometric) spinel ferrites” is used here to mean compounds of the spinel type based on γ-Fe₂O₃ modified by replacing some of the ferric ions and vacancies with metal cations other than ferric cations. To represent super-stoichiometric (cation-deficient) spinel oxides while keeping, in the formula, a number of metal atoms equal to 3 (as in the formula Fe₃O₄), it is necessary to write their formula in a form of the type:
XₓFe₃₋ₓO_{4+δ}
where X represents at least one divalent metal cation, x is a number not exceeding 1, Fe represents, by convention, the trivalent iron ion, O represents an O²⁻ ion and δ is a positive number. Another way of representing these superstoichiometric (cation-deficient) spinel oxides, while this time keeping number of oxygen atoms equal to 4 (as in the formula Fe₃O₄), is to write its formula in an equivalent form involving vacancies:
XₓFe_{3-x-y y}O₄,
the symbol representing the vacancies.

Among oxidizable stoichiometric spinel oxides of formula I, mention may in particular be made of magnetite Fe₃O₄, iron chromite FeCr₂O₄ (J. Appl. Phys. 18, 520, 1947) and iron aluminate FeAl₂O₄ (Fichier JCPDS 03-0894). Mention may also be made of manganese oxide Mn₃O₄ and manganites corresponding to the above formula I with M=Mn and δ=0 (or close to zero). Among these manganites, mention may be made of nickel manganites of formula Ni_{z}Mn_{3-z}O₄ and nickel copper manganites of formula Ni_{z}Cu_{y}Mn_{3-y-z}O₄ (see especially C. Drouet et al., Solid State Ionics, 123, 25-37 (1999) and the references cited in that document). All these stoichiometric spinel oxides are oxidizable to cation-deficient nonstoichiometric spinel oxides.

Mention may also be made of:
compounds of formula I based on iron and manganese;
compounds of formula I based on chromium and copper; and
compounds of formula I based on iron, manganese, cobalt and copper.

Moderately superstoichiometric (and therefore still oxidizable) spinel oxides correspond especially to products of formula I for which the number δ is positive but close to zero, for example less than 0.1 (or 0.05). They can also be used as material for the sensitive film according to the invention if their oxidation makes it possible to obtain sufficient optical contrast between the oxidized material and the nonoxidized material. This can be determined in each case by simple routine experiments.

Anion-deficient spinel oxides are also known, these also being called substoichiometric spinel oxides. Substoichiometric spinel oxides correspond especially to oxides of formula I for which the number δ is negative. Such products are obviously oxidizable and can therefore be used as material for the sensitive film according to the invention. The substoichiometric spinel oxides are transformed to stoichiometric spinel oxides by oxidation.

Among substoichiometric spinel oxides of formula I, mention may principally be made of those for which M′ represents copper. Nonstoichiometric copper ferrite coming from the reduction of some of the cupric ions of the cupric ferrite CuFe₃O₄ may be mentioned (see, for example, X. X. Tsang et al., J. Sol. Stat. Chem., 79, 250-262 (1989)) and also substituted copper ferrites (formula I with M═Fe, M′═Cu and, when z is different from zero, M″ chosen from Co, Mg, Ni, Cu and Zn). These products, for example deposited by sputtering, form substoichiometric oxides spontaneously.

In general, the spinel oxide compositions may be modified by dopants—these are not represented in the formula (I) and do not necessarily form part of the crystal lattice. The use of many dopants has been described for this type of compound. The presence of dopants may, for example, help to regulate the crystallization. In general, the dopants are present in the form of oxides in a proportion by weight not exceeding 1-2 wt % relative to the weight of oxidizable spinel oxide. The dopants are, for example, silicon, phosphorus, boron, alkaline-earth metals (in particular, Ca, Ba and Sr), alkali metals (for example Na, K and Li), gallium, germanium, arsenic, indium, antimony, bismuth, lead, etc.

In general it has been found that, when mixtures of oxides having the composition of stoichiometric spinel oxides are being deposited, the thin film deposited spontaneously adopts a spinel crystal structure. The material based on stoichiometric spinel oxide that constitutes the sensitive film is deposited in the form of a polycrystalline material. The deposited film is in a lowly crystallized state. In other words, the size of the crystallites is small, generally less than 30 nm. The term “crystallites” is understood here to mean microcrystalline domains that diffract X-rays coherently and are therefore single crystals, the dimensions of which may be determined especially by X-ray diffraction or by transmission electron microscopy. The data recording (writing) operation carried out in accordance with the invention consists in locally heating a small region of the sensitive film in the presence of air. This results in the oxidation of the oxidizable ions, such as the M′ⁿ⁺ ions. It has been found that the low crystallization state of the deposited films, and their small thickness (ranging, for example, from 10 to 100 nm approximately and preferably from 20 to 80 nm approximately) facilitate their oxidation at moderate temperatures (for example above 200° C.). The structure of the sensitive film in the written regions is unchanged—it is a spinel structure of stoichiometric or nonstoichiometric type depending on whether the starting product is substoichiometric or stoichiometric respectively, since this structure is the result of an oxidation. This oxidation treatment is accompanied by an increase in the size of the crystallites, due to the local heating during writing and due also to the exothermicity of the oxidation reaction.

It has been discovered in particular that, by depositing a thin film, generally with a thickness of less than approximately 100 nm, of stoichiometric spinel oxide optionally coated with an absorbent layer having, at the wavelength used, an optical absorption greater than that of the spinel oxide, the light energy absorbed, which is converted into heat, heats the irradiated region sufficiently to allow oxidation of the thin film in air, with at least partial transformation to a nonstoichiometric (cation-deficient) spinel oxide in said region. When the initial oxide is substoichiometric, the product of the oxidation is stoichiometric. The abovementioned absorbent layer is in fact a layer that is both absorbent and reflective, for example a metal film. This film must have a low enough thickness and/or a high enough porosity for the ambient oxygen to be able to diffuse into the layer of spinel oxide to be oxidized during the write operation.

The virgin (unirradiated) regions and the irradiated regions then exhibit sufficient optical contrast to allow read-out using suitable optical means.

If the light energy used for the writing is greater than that sufficient to oxidize the initial stoichiometric spinel oxide into a nonstoichiometric spinel oxide, it is possible for there then to be at least partial transformation into another crystal structure, for example of the carborundum type, in a manner similar to the transformations of the nonstoichiometric spinel oxides described in the application PCT WO 99/14747. Such a transformation again provides here sufficient optical contrast between irradiated and unirradiated regions to allow read-out by optical means. However, it is preferred to operate with low writing power levels. This thus avoids having to work the laser sources (diodes) employed at the limits of their possibilities, so as to extend their lifetime. Moreover, diodes presently emitting blue radiation have power levels that generally do not exceed 10 mW. Their use for storing data therefore involves the use of low writing power levels. The situation is therefore preferably one in which the write conditions prevent the formation of crystal structures of the carborundum type in the irradiated regions. However, before formatting the disk, when it is desired to etch the format directly into the sensitive film, higher power levels may be used (see Example 4 below). It is therefore necessary to make a clear distinction between the operation of etching the format and the actual write operation.

The films are preferably produced under conditions (known per se) such as to promote the occurrence of compressive or tensile mechanical strains in their plane. This is because, during the write operation, these strains create a topographic deformation leading to the formation of a bump (a state of compression) or a pit (a state of tension) conducive to increasing the optical contrast generated by the oxidation.

For example, to increase the mechanical strains in the sensitive film when it is deposited by sputtering, it is possible to select, by simple routine experiments, the spinel oxides that are capable of absorbing at least a predetermined percentage of the power of an incident light beam, at least within part of the 400-600 nm wavelength range, this percentage of absorption being sufficient for the irradiation to cause heating of the sensitive film allowing the initial spinel oxide to oxidize.

The material of the sensitive film may be chosen from those essentially consisting (apart from the optional dopants) of a spinel oxide thus selected. In particular, routine experiments are carried out to choose those that meet optical contrast conditions sufficient to allow read-out.

The sensitive films obtained according to the invention may be used in particular in optical media having the following optical structures:
substrate/spinel oxide;
substrate/spinel oxide/absorbent metal film;
substrate/spinel oxide/dielectric/absorbent metal film; and
substrate/dielectric/spinel oxide/absorbent metal film.

The production and use of such structures are known per se. It is possible to work in reflection or in transmission. In reflection, the read and write operations are carried out either on the substrate side, the latter then being transparent, or on the sensitive film (or absorbent metal film) side. Another possibility (read-out in transmission) consists in making the incident laser beam emit on one side of the optical medium and in reading the transmitted laser beam on the other side, by analyzing it using a detector.

The recording material, the dielectric and the metal reflector are deposited on the substrate in the form of thin films using the standard techniques, for example radiofrequency sputtering, vacuum evaporation or laser ablation and vapor deposition.

The substrate may be made of glass, metal (in this case, there is no need to provide a metal film deposited on the sensitive film) or plastic (for example polycarbonates, polyimides or polynorbornene).

It will be recalled that, in optical data media, the dielectric layers are used especially for their antireflection properties. As dielectrics that can be used, mention may be made of nitrides (for example aluminum nitride or silicon nitride), oxides (for example silica) or fluorides (for example calcium fluoride).

Since the various layers (apart from the substrate) of the optical data medium are layers of small thickness, this thickness may be optimized by calculation or experimentally, depending on the optical characteristics of said layers, so as to ensure the optimum optical contrast between the modified (irradiated) regions and the unirradiated regions.

The optical media obtained according to the invention may be disks, cards or tapes. They may be prepared and formatted in the usual manner.

In particular embodiments, the method of the invention may also have the following features, taken individually or, as the case may be, in combination:
said recording is carried out by subjecting, in succession, along a recording track, regions of the sensitive film to irradiation by means of a light beam so that said irradiation causes local heating of said region up to a temperature allowing said material of the sensitive film in said region to oxidize;
the irradiation is carried out with a light beam of wavelength less than 800 nm and in particular less than 600 nm;
the material of the thin film is chosen from those for which the oxidation occurs at a temperature not exceeding about 400° C. and in particular not exceeding about 300° C.;
said metal M′ capable of having several oxidation states is chosen from copper, iron, manganese, molybdenum, vanadium, tungsten and the rare earths; the M′ⁿ⁺ ions may be chosen, for example, from the following ions: Cu⁺, Fe²⁺, Mn²⁺, Mn³⁺, Mo³⁺, Mo⁴⁺, V³⁺, V⁴⁺, W³⁺, W⁴⁺, Eu²⁺, Tb³⁺, etc; and
said thin film is itself coated with an absorbent metal film, which for example may be a film of titanium, aluminum, chromium, molybdenum, nickel, or an alloy of these metals, for example a Ti—Al alloy. This film may have, for example, a thickness of 5 to 20 nm, and it has been found that its presence does not prevent the sensitive film from oxidizing during the write operation.

The subject of the invention is also the use, as constituent material of a sensitive film of a write-once read-many optical data medium, of a material which comprises, apart from dopants optionally present, an oxidizable spinel oxide as defined above.

The invention also relates to a write-once read-many optical medium comprising a sensitive film deposited on a substrate, in which medium the sensitive film is made of a material comprising, apart from dopants optionally present, an oxidizable spinel oxide as defined above, and in which medium said sensitive film comprises written regions that are modified by the write operation and virgin (unwritten) regions that are unmodified (and therefore oxidizable). Owing to the indications shown above, it may be seen that there exists two embodiments of these recorded optical media. In a first embodiment, the sensitive film (and therefore the virgin regions) consists of substoichiometric spinel oxide (with a spinel-type structure) and the written regions (but not necessarily the formatting regions when the format is etched into the sensitive film) consist of corresponding stoichiometric spinel, also with a spinel structure. In the second embodiment, the sensitive film (and therefore the virgin regions) consists of stoichiometric (or very slightly nonstoichiometric) spinel oxide, whereas the written regions (but not necessarily the formatting regions) have a cation-deficient (or more highly nonstoichiometric) spinel structure. A characteristic property common to these two embodiments is that the light absorption parameter (index k) of the virgin regions is modified when the recorded optical medium is subjected to an oxidizing heat treatment (for example at a temperature possibly ranging from 200 to 400° C.), whereas said light absorption parameter of said virgin regions is substantially unchanged after the same heat treatment carried out in an inert atmosphere (for example in a nitrogen atmosphere). This modification results from the fact that, for a given light radiation, the intensity of the absorption varies. Over the entire light spectrum, this results in a displacement of the absorption maximum. In practice, a change in color of the virgin regions of the medium is therefore observed after the oxidizing heat treatment, whereas the color of the virgin regions remains practically unchanged after a similar heat treatment but carried out in an inert atmosphere.

Thus, there is optical contrast between the written regions and the virgin regions, this optical contrast being sufficient to allow read-out. The optical contrast is considered to be sufficient for allowing read-out if it is at least equal to 5% and in particular greater than 10%.

The regions modified for writing may be further distinguished from the virgin regions by crystallite sizes generally greater than the crystallite sizes of the virgin regions. Furthermore, their oxygen content is greater than that of the virgin regions.

In a recorded medium, the written regions represent a relatively small proportion of the area of the optical medium, so that in practice the color of this surface is very close to that of an unrecorded medium. One feature of the recorded media is (in a destructive technique) that, like the unrecorded media, they change color after an oxidizing heat treatment but not after a heat treatment in an inert atmosphere.

The invention does not extend to recorded optical media in which the modified (written) regions have a crystal structure other than a spinel structure, or else are partially melted (except possibly in the formatting regions, when the format is etched directly into the sensitive film—see the experimental part below).

The invention furthermore relates to a method of reading an optical medium as defined above, in which said modified regions and said unmodified regions are identified, using optical means in a manner known per se. The optical means used for the read-out encompass here optoelectronic means, known per se, allowing the light power levels to be analyzed and compared.

Read-out of the recorded information may take place, especially using a focused light beam emitted by a laser, either in transmission or in reflection, in a manner known per se. It is also possible to use conventional commercial readers or else readers suitable for what are called near-field techniques.

For example, the optical read means compare the light power levels transmitted or reflected by regions of the sensitive film, which have been irradiated in succession by a read light beam, along the recording tracks.

The following examples illustrate the invention:

### EXAMPLE 1

### General Method of Producing Thin Co—Cu Ferrite Films on a Glass Substrate

Cobalt copper ferrite (Co—Cu ferrite) films were deposited on a glass substrate by radiofrequency sputtering using a target prepared by intimately mixing Fe₃O₄, Co₃O₄ and CuO oxide powders in the molar proportions 1/0.05/0.85, followed by sintering at 1000° C. for 2 hours.

The operating conditions were the following:
argon plasma;
chamber pressure: 0.1 to 0.5 Pa;
power: 2.5 W/cm²;
presputtering: 30 minutes;
target/substrate distance: 5.2 cm;
coating thickness: from 10 to 100 nm.

The coatings were deposited on a medium rotating at a speed of 1 revolution per second.

Analysis, using transmission electron microscopy and atomic force microscopy, of the thin films deposited showed that they were polycrystalline films, the mean crystallite size of which being generally less than 30 nm. X-ray diffraction analysis of the as-produced thin films showed that the crystal structure was that of a spinel.

The chemical composition of the deposited films was close to Co_{0.15}Cu_{0.85}Fe₂O₄, but was in fact anion-deficient (substoichiometric), as shown in particular by the fact that the deposited thin film was oxidizable (see the following examples). The chemical composition was therefore Co_{0.15}Cu_{0.85}Fe₂O_{4-δ}. The precise value of δ was not determined as it is not of interest per se, the essential point being that the sensitive film is oxidizable, thereby providing optical contrast between oxidized regions and unoxidized regions.

### EXAMPLE 2

### Change in the Refractive Index n and in the Absorption Index k of a Thin Ferrite Film before and after Annealing in Air

A thin Co—Cu ferrite film was prepared according to Example 1 under the following conditions:
pressure: 0.5 Pa;
thickness of the deposited film: 70 nm.

The optical indices n and k were determined, in a manner known per se, by ellipsometry, in a wavelength range going from 480 to 780 nm approximately. The measurements were made before and after an oxidizing treatment, namely annealing at 450° C. in air for one hour.

The results of these measurements are given below.

Refractive Index:

Before annealing, the refractive index was about 2.5 over the entire wavelength range studied.

After annealing, the index n (about 2.5 at 476 nm) increased with wavelength up to a maximum of about 3.1 at 600 nm and then decreased, reaching a value of about 2.7 at 775 nm.

Absorption Index:

Before annealing, the index k decreased from about 1 to about 0.7 for wavelengths going from 480 to 780 nm. After annealing, the index k was always less than or equal to 0.2.

Thus, the oxidizing treatment of a thin film having. a stoichiometric spinel ferrite composition appreciably modifies the values of the optical indices n and k.

There therefore exists between these indices, before and after oxidizing treatment, differences sufficient to provide a substantial optical contrast that can be put to advantage for reading, on a sensitive film, data bits recorded in the form of microdots, which are optically detectable, corresponding to microdomains in which the spinel ferrite of the sensitive film will have been oxidized.

### EXAMPLE 3

### Study of the Reflectivity

Thin ferrite films of various thicknesses were deposited on a glass substrate (thickness: 1.2 mm) in accordance with the method of Example 1, operating at a pressure of 0.5 Pa. The reflectivity of the structure obtained was studied before and after a 450° C. oxidizing treatment (as in Example 2) as a function of the ferrite thickness.

At a wavelength of 780 nm, the difference in reflectivities before and after treatment passes through a maximum for a ferrite thickness of about 70 nm. For such a 70 nm ferrite film, the reflectivity goes from 23% before oxidizing treatment to 38% after oxidizing treatment.

At a wavelength of 488 nm, the difference between the reflectivities passes through a maximum for a ferrite thickness of about 50 nm. For such a film having a thickness of 50 nm, the reflectivity goes from 25% before oxidizing treatment to 40% after oxidizing treatment.

Thus, the reflection coefficients, before and after oxidizing treatment, are sufficiently different to provide a satisfactory optical contrast for detecting oxidized and unoxidized regions, and therefore allowing read-out by an optical method using reflection.

### EXAMPLE 4

### General Write Conditions

In the examples below, the data write and read-out were effected using a tester designed from an ATG6000 reader (sold by NEW ATG). This tester allowed disks having a diameter of 5¼ inches or 12 inches to be used. The rotation speed of the disks was 1200 rpm.

The writing power levels depended on the wavelength of the laser, and also on the materials and optical structures studied, and varied from 15 to 30 mW at 780 nm and from 4 to 30 mW at 488 nm. The read-out power was at most 1.5 mW. The lasers were used with pulse durations ranging from 50 ns to 150 ns.

A laser source was placed on one side of the substrate both for writing and reading.

To make the disks exploitable by the read/write head, it was necessary for the surface of the disks to be inscribed with optical information that constituted the format. This information allowed the optical head to be guided and focused, and allowed these actions to be synchronized with the period of rotation of the medium. A special machine, of type known per se, was used for formatting by heating the ferrite film with a laser spot having a power of greater than 30 mW. In the irradiated points, the regions partly melted. These therefore had, compared with the virgin regions, a maximum optical contrast assigned the value 100%. This optical signal is taken as the reference signal. To evaluate the signals corresponding to the data subsequently written by the read/write head, chemical, crystalline and topographic modifications of the ferrite films according to the present invention were used. The results of reading the signals corresponding to the data written on the disk were expressed as a percentage of the reference signal.

### EXAMPLE 5

### Demonstration of the Phenomena for Writing by Laser Irradiation: Effect of Crystallization

A thin ferrite film was deposited by radiofrequency sputtering on a substrate formed by a microscope grid under the following conditions:
pressure: 0.5 Pa;
power: 2.5 W/cm²;
target/substrate distance: 5.2 cm;
rotation speed of the substrate: 1 rpm;
presputtering: 30 minutes;
thickness of the ferrite film: 20 nm.

The composition of the target was the same as that of the target of Example 1. A substoichiometric cobalt copper ferrite was again obtained.

The specimen obtained was irradiated in static mode (i.e. with the ferrite film stationary during writing) by a 488 nm focused laser beam with a power of 9.5 mW. Transmission electron microscopy observation of the irradiated regions revealed local crystallization of the ferrite film, resulting in an increase in the crystallite size. The mean crystallite size ranged from 7.5 nm (unirradiated regions) to 40 nm (irradiated regions).

### EXAMPLE 6

### Demonstration of the Phenomena Allowing Writing: Effect of Strains in the Spinel Ferrite Films

Thin ferrite films were deposited on a glass substrate (a disk 5.25 inches in diameter and 1.2 mm in thickness) by carrying out the. procedure as in Example 1. A disk coated with a thin (substoichiometric) ferrite film 40 nm in thickness was deposited at a pressure of 0.1 Pa.

The writing was carried out as described in Example 4.

With a writing power of 10 mW (488 nm wavelength), the read signals corresponded to 25% of the reference signal. With a writing power of 16 mW (488 nm wavelength), the read signals amounted to 80% of the reference signal.

At 488 nm, the minimum writing power was 10 mW.

The same disk was then treated in a nitrogen atmosphere at 250° C. for one hour, and then left to cool down in the oven.

Since the oxidation state was constant, this heat treatment modified only the strained state in the thin ferrite film.

After this treatment, the minimum writing power at 488 nm was 14 mW (read signal 20% of the reference signal).

Thus, the strains present in the thin film deposited facilitate writing, since the reduction in strains has the effect of increasing the minimum writing power.

### EXAMPLE 7

### Demonstration of the Phenomena Allowing Writing: Effect of Oxidation:

A thin ferrite film 70 nm in thickness was deposited at a pressure of 0.5 Pa in a similar manner to that described in the previous example.

A writing power of 12.5 mW (wavelength: 488 nm) made it possible to obtain a read signal amounting to 80% of the reference signal.

The disk was then treated for one hour in air at 250° C.

After this treatment, writing was no longer possible at 12.5 mW.

Thus, the oxidizable nature of the thin deposited film, making it possible for the metal cations to oxidize during the irradiation, which was carried out in air, allowed writing, but the recorded medium obtained could not be rewritten under the same conditions. The recorded medium obtained is therefore of the WORM type.

### EXAMPLE 8

### Write Test on a Glass/ferrite Optical System: Topography of the Irradiated Regions

A glass substrate 5.25 inches in diameter and 1.2 mm in thickness was used. A ferrite film was deposited as described in Example 1 by radiofrequency sputtering at an argon pressure of 0.5 Pa. The thickness of the ferrite layer deposited was 70 nm.

The write operations were carried out between the 62 mm and 68 mm radii. The recording was performed using a focused laser beam emitting at 488 nm with various writing power levels ranging from 9 to 16 mW.

The power levels indicated are peak power levels reached during the modulation pulses of the focused laser.

For writing power levels of between 12 and 16 mW, the read-out gives a signal of 100% relative to the reference signal. The observation by atomic force microscopy (AFM) shows that the bits were in the form of bumps with a perforated center.

For a writing power of 11 mW, the read-out gave 50% of the reference signal. Topographic deformation in the form of bumps was demonstrated by AFM. The mean bit diameter was 0.7 μm and the height of the deformation was 100 nm.

For writing power levels from 9 to 10 mW, the read signal was 5% of the reference signal and the deformation in the form of bumps observed had a diameter of 0.6 μm and a height of 70 nm.

Thus, the optical structure studied could be used with a writing power of between 9 and 11 mW at 488 nm.

### EXAMPLE 9

### Recording by Laser Irradiation of a Ferrite Film Deposited on a Resist

As substrate, a glass disk 12 inches in diameter and 1.2 mm in thickness was used, the disk being covered with a resist layer 25 μm in thickness in which the formatting was inscribed. A thin (substoichiometric) ferrite film was deposited on the resist layer using the method described in Example 1 at an argon pressure of 0.5 Pa.

The thickness of the ferrite film deposited was 70 nm.

The writing was carried out from the 62 mm radius with a laser emitting at a wavelength of 780 nm.

For a writing power of 13 mW, no read signal was observed. Observations by AFM revealed topographic deformation with a diameter of 0.75 μm and a height of 40 nm.

For writing power levels ranging from 14 to 19 mW, AFM revealed recordings in the form of topographic deformations whose diameter and height increased with the writing power.

For writing power levels of between 19 and 25 mW, examination by AFM showed bumps whose center was perforated. The signal reached 100% of the reference signal.

The resist was a conventional duplicating resist obtained by copolymerization of a monomixture based on trimethylolpropane triacrylate and tripropylene glycol diacrylate, in the presence of a photoinitiator (sold under the reference Irgacure 651 by CIBA).

### EXAMPLE 10

### Recording by Laser Irradiation of a Co—Cu Ferrite Film Deposited on a Resist

The procedure was as in Example 9, the only difference being that the thin ferrite film had a thickness of 50 nm. The write operation was carried out on the disk from the 97 mm radius at a wavelength of 780 nm.

For writing power levels greater than or equal to 21 mW, AFM examination revealed bits in the form of bumps with a perforated center. The signal was 100% relative to the reference signal.

For writing power levels ranging from 11 to 19 mW, AFM has revealed bits in the form of topographic deformations (diameter 0.5 μm and height 40 nm for a writing power of 11 mW).

### EXAMPLE 11

### Recording on a Glass/ferrite/titanium Optical Structure

The ferrite film was deposited by radiofrequency sputtering from a Co—Cu ferrite target, as described in Example 1, on two glass substrates 5.25 inches in diameter and 1.2 mm in thickness, with an argon pressure of 0.1 Pa. The thickness of the ferrite film deposited was 70 nm. Next, a titanium reflective film on the ferrite film was deposited on one of the substrates, by sputtering at 2 W/cm² in argon (0.5 Pa).

The titanium film had a thickness of 12 nm.

A write operation was performed with a laser emitting at 780 nm for power levels between 15 and 29 mW.

The read-out power was 1 mW.

The structure without titanium did not allow the read signal to be detected, even for a writing power of 29 mW.

With the structure including the titanium film, for writing power levels of 17 and 22 mW, read signals of 10% and 80% relative to the reference signal were observed respectively. Examination by AFM revealed bits in the form of topographic deformations (0.5 μm in diameter and 25 nm in height for 17 mW).

For writing power levels equal to or greater than 23 mW, AFM examination revealed bumps whose center was perforated. The signal reached 100% of the reference signal.

It should be noted that the presence of the 12 nm titanium film did not prevent the ferrite film from oxidizing during isolation.

### EXAMPLE 12

### Writing by Laser Irradiation of a Thin Magnetite Film

A thin magnetite film was deposited by sputtering from a magnetite (Fe₃O₄) target directly on a glass disk 12 inches in diameter coated beforehand with a conventional duplicating resist, containing the format, obtained as indicated in Example 9 above. The deposition conditions were the following:
pressure: 0.5 Pa;
power: 2.5 W/cm²;
target/substrate distance: 5.2 cm;
rotation speed of the substrate: 1 rpm;
presputtering: 30 minutes;
thickness of the magnetite film deposited: 70 nm.

The write operation was carried out at 488 nm with power levels between 8 and 20 mW, at the 108 mm radius of the disk.

Writing was possible for power levels greater than or equal to 8 mW. The read signal, for a writing power of 8 mW, was 5% with respect to the reference signal.

For a writing power of 12-14 mW, the read-out signal was 60%.

Next, a treatment at 200° C. in air for 24 hours was carried out. After this treatment, the minimum power for writing was 14 mW (read signal: 50%).

The heat treatment allowed the strains in the film to relax and the ferrous ions to oxidize, thereby decreasing the sensitivity of the thin film to writing after treatment (the amount of oxidizable ions remaining being smaller).

### EXAMPLE 13

### Change in the Absorption of a Sub-stoichiometric Copper Ferrite upon Annealing in Air at 350° C. for 5 Hours.

A thin film of spinel ferrite CuFe₂O_{4-δ} was prepared by replacing the target of Example 1 with a CuFe₂O₄ target, but keeping the same radiofrequency sputtering deposition conditions.

The optical absorption of a CuFe₂O_{4-δ} ferrite film thus prepared was measured in the visible spectral range. The same film was then oxidized in air at 350° C. for 5 hours and its optical absorption was measured under the same conditions as previously. The color change due to the oxidation, which could be observed by simple examination with the naked eye, had the result of modifying the absorption spectrum as indicated in the table below:

Absorption (%)

| Wavelength (nm) | Before treatment | After treatment |
|---|---|---|
| 780 | 0.362 | 0.274 |
| 680 | 0.391 | 0.282 |
| 650 | 0.402 | 0.285 |
| 600 | 0.430 | 0.295 |
| 560 | 0.469 | 0.329 |
| 520 | 0.538 | 0.404 |
| 500 | 0.582 | 0.460 |
| 480 | 0.639 | 0.528 |
| 460 | 0.706 | 0.611 |
| 440 | 0.800 | 0.734 |
| 420 | 0.911 | 0.884 |

### EXAMPLE 14

### Deposition of a Sensitive Film Based on Stoichiometric or Substoichiometric Spinel Oxides

Similarly, films having the following compositions:
Mn_{1.9}Fe_{1.1}O₄
Mn_{1.5}Fe_{0.5}O₄
Cu_{0.7}Co_{0.3}Mn_{0.75}Fe_{1.25}O_{4-δ}
Cu_{0.5}Co_{0.5}MnFeO_{4-δ}
CuCr₂O_{4-δ}
   were deposited on the glass disks by sputtering.

Each optical medium obtained could be modified by writing with a laser beam. A recorded optical medium of the WORM type was obtained.

1. A method of recording data in digital form on a write-once read-many optical medium comprising a sensitive film deposited, in thin-film form, on a substrate, said method comprising recording steps consisting in heating, locally and in succession, regions of the sensitive film, in which said sensitive film is made of an oxidizable material which comprises, apart from optional dopants present, an oxidizable spinel oxide comprising, in oxide form, at least two transition metals having different oxidation states, and in which said heating is carried out under conditions allowing oxidation of said oxidizable spinel oxide.

2. The method as claimed in claim 1, in which said oxidizable spinel oxide satisfies formula I:
Mₓ³⁺M′_{y}ⁿ⁺M″_{z}²⁺O_{4+δ}²⁻ (I)
in which M represents at least one trivalent metal chosen from Fe, Mn, Co, Cr and Al;
M′ represents at least one metal that can have several oxidation states;
M″ is a divalent metal chosen from Mg, Co, Ni, Cu and Zn;
n is the valency of M′ in the M′ⁿ⁺ ion, which is an ion that can oxidize to an ion of higher valency than n;
x represents the quantity of atoms of metal M and may vary from 0.8 to 2.8 approximately;
y is a number representing the quantity of M′ atoms and is at least equal to approximately 0.2;
z is a number, possibly zero, representing the quantity of M″ atoms;
δ is a number equal to (3x+ny+2z−8)/2; and
the sum (x+y+z) being equal to 3.

3. The method as claimed in claim 1, in which said recording is carried out by subjecting, in succession, along a recording track, regions of the sensitive film to irradiation by means of a light beam so that said irradiation causes local heating of said region up to a temperature allowing said material of the sensitive film in said region to oxidize.

4. The method as claimed in claim 3, in which said irradiation is carried out with a light beam of wavelength less than 800 nm or less than 600 nm.

5. The method as claimed in claim 1, in which the material of the thin film is chosen from those for which the oxidation occurs at a temperature not exceeding about 400° C., or not exceeding 300° C.

6. The method as claimed in claim 1, in which said oxidizable spinel oxide contains, in oxide form, a metal capable of having several oxidation states chosen from copper, iron, manganese, molybdenum, vanadium, tungsten and the rare earths.

7. The method as claimed in claim 1, in which said oxidizable spinel oxide is chosen from:
copper ferrites, optionally substituted, satisfying formula I with M═Fe and M′═Cu;
compounds of formula I based on iron and manganese;
compounds of formula I based on chromium and copper;
compounds of formula I based on iron, manganese, cobalt and copper;
stoichiometric spinel oxides chosen from Fe₃O₄, FeCr₂O₄, FeAl₂O₄ and Mₙ₃O₄;
manganites satisfying formula I with M═Mn and δ equal to zero or close to zero; and
nickel copper manganites of formula Ni_{z}Cu_{y}Mn_{3-y-z}O₄ in which y is a number representing the quantity of Cu atoms and is at least equal to approximately 0.2, and z is a number, possibly zero, representing the quantity of Mn atoms.

8. The method as claimed in claim 1, in which said sensitive film is coated with a metal film.

9. A sensitive film of a write-once read-many optical data medium comprising an oxidizable material which comprises, apart from dopants optionally present, a spinel oxide comprising at least two transition metals having different oxidation states.

10. The sensitive film as claimed in claim 9, in which said material is an oxidizable spinel oxide that satisfies formula I:
Mₓ³⁺M′_{y}ⁿ⁺M″_{z}²⁺O_{4+δ}²⁻ (I)
in which M represents at least one trivalent metal chosen from Fe, Mn, Co, Cr and Al;
M′ represents at least one metal that can have several oxidation states;
M″ is a divalent metal chosen from Mg, Co, Ni, Cu and Zn;
n is the valency of M′ in the M′ⁿ⁺ ion, which is an ion that can oxidize to an ion of higher valency than n;
x represents the quantity of atoms of metal M and may vary from 0.8 to 2.8 approximately;
y is a number representing the quantity of M′ atoms and is at least equal to approximately 0.2;
z is a number, possibly zero, representing the quantity of M″ atoms;
δ is a number equal to (3x+ny+2z−8)/2; and
the sum (x+y+z) being equal to 3.

11. A write-once read-many optical medium comprising a sensitive film deposited on a substrate, in which medium the sensitive film is made of an oxidizable material which comprises, apart from dopants optionally present, an oxidizable spinel oxide comprising at least two transition metals having different oxidation states, and in which medium said sensitive film comprises virgin regions that are unmodified and oxidizable and regions that are modified by the write operation.

12. The optical medium as claimed in claim 11, in which the material constituting said virgin regions is an oxidizable spinel oxide that satisfies formula I:
Mₓ³⁺M′_{y}ⁿ⁺M″_{z}²⁺O_{4+δ}²⁻ (I)
in which M represents at least one trivalent metal chosen from Fe, Mn, Co, Cr and Al;
M′ represents at least one metal that can have several oxidation states;
M″ is a divalent metal chosen from Mg, Co, Ni, Cu and Zn;
n is the valency of M′ in the M′ⁿ⁺ ion, which is an ion that can oxidize to an ion of higher valency than n;
x represents the quantity of atoms of metal M and may vary from 0.8 to 2.8 approximately;
y is a number representing the quantity of M′ atoms and is at least equal to approximately 0.2;
z is a number possibly zero, representing the quantity of M″ atoms;
δ is a number equal to (3x+ny+2z−8)/2; and
the sum (x+y+z) being equal to 3.

13. A method of reading an optical medium, in which the optical medium is as defined in claim 11 and in which said modified regions and said unmodified regions are identified using optical means.
